(19) United States
(12) Patent Application Publication
(10) Pub. No.: US 2018/0235051 A1
(43) Pub. Date: Aug. 16, 2018

(54) ILLUMINATION DEVICE FOR CREATING ATMOSPHERE OF LIVING ENVIRONMENT

(71) Applicant: Chang-Hong Chen, Hsinchu County (TW)

(72) Inventor: Chang-Hong Chen, Hsinchu County (TW)

(21) Appl. No.: 15/606,155

(22) Filed: May 26, 2017

(30) Foreign Application Priority Data
Feb. 13, 2017 (TW) 106202084

(51) Int. Cl. H05B 33/08; F21V 17/06; F21V 23/06; F21K 9/232; F21K 9/237; F21K 9/238

(52) U.S. Cl. CPC H05B 33/0857; F21V 17/06; F21V 23/06; F21Y 2113/13; F21K 9/237; F21K 9/238; H05B 33/0845; F21K 9/232

(57) ABSTRACT

An illumination device for creating an atmosphere of a living environment includes a first lamp, a second lamp and a housing. The first lamp is configured to provide a light source for the atmosphere of the living environment, the second lamp is configured to provide an illumination light source; and the housing has a first portion and a second portion for accommodating the first and the second lamps respectively, wherein the first and the second portions block the illumination light source and the light source for the atmosphere of the living environment respectively.

### CROSS REFERENCE TO RELATED APPLICATION

This application claims the benefit of the Taiwan Patent Application No. 106202084, filed on Feb. 13, 2017, at Taiwan Intellectual Property Office, the disclosures of which are incorporated herein in their entirety by reference.

### TECHNICAL FIELD

Embodiments in the present disclosure are related to an illumination device, in particular an illumination device for creating an atmosphere of a living environment.

### BACKGROUND

Most of the traditional lamp devices use tungsten lamps or fluorescent tube energy-saving lamps, but such lamps have low efficiency to convert electrical energy into light energy, so the energy consumption is large and lots of energy is lost. In order to achieve the required brightness, a high resistance wire filament is used in the tungsten lamp, so the high temperature will impact on the durability of the tungsten filament during the working process, and the high temperatures caused also creates a safety hazard. Furthermore, the fluorescent tube contains toxic metal mercury, and the fluorescent tubes are easily broken down, resulting in the release of mercury into the environment. Thus, such lamps are harmful to the human body. In addition, the light of the above lamp devices are toovaried, and the brightness is not enough.

With the advance of technology in recent years, the LED lamp has gradually replaced the tungsten lamp, halogen lamps, fluorescent tubes, etc. because the energy conversion efficiency of the LED lamp is higher, the light emitted by the LED lamp is closer to that from the sun, and therefore people feel it is very comfortable visually. Research shows that the color temperature of 5500° K will be more favorable to the eyes, and a color temperature of 6500° K of the LED lamp is closer to that from the sun than that of 4200° K of the xenon lamp. In addition, there are a lot of other advantages of the LED lamp. For example, it is not only power saving, has high brightness, and lasts longer, but also the price is more cheaper; has less heat radiation, is less wasted power, and has a short light up time, which can reach full illumination more quickly. Therefore, the advantages of the LED lamp make it superior to other types of lamps in the application.

In the field of decorative lamps, the LED lamp is becoming more and more widely used. In the current market, bulbs which can emit a light with different colors are sold separately from the bulbs with an illumination function, and they are installed in different lamps. Because of that, separation of the installation space and equipment for different choice of functioned lighting can be large and costly.

In view of the above, it is expected that a single lamp device can not only illuminate the living space, but also offer numerous color lighting options.

### SUMMARY OF EXEMPLARY EMBODIMENTS

In accordance with a preferred embodiment of the present disclosure, the present invention discloses an illumination device for creating an atmosphere for a living environment. The illumination device includes a first lamp, a second lamp and a housing. The first lamp is configured to provide a light source for the atmosphere of the living environment; the second lamp is configured to provide an illumination light source; and the housing has a first portion and a second portion for accommodating the first and the second lamps respectively, wherein the first and the second portions block the illumination light source and the light source for the atmosphere of the living environment respectively.

In accordance with a further embodiment of the present disclosure, the present invention discloses an illumination device for providing an atmosphere for a living environment. The illumination device includes a first lamp, a second lamp and a housing. The first lamp is configured to provide a light source for the atmosphere of the living environment. The second lamp is configured to provide an illumination light source. The housing accommodates the first and the second lamps.

In accordance with a further embodiment of the present disclosure, the present invention discloses an illumination device, which includes a first lamp shell and a second lamp shell. The first lamp shell is configured to enclose at least a first lamp; and the second lamp shell is configured to enclose at least a second lamp, wherein the first and the second lamp shells are coupled back-to-back.

According to the illumination device for creating an atmosphere for a living environment in the preferred embodiment of the present disclosure, the first lamp for providing an atmosphere for a living environment and the second lamp for an illumination are separated from each other by a light-blocking unit. The atmosphere light and the illumination light will not interface each other, and these two lamps are integrated in one single illumination device. The user can not only adjust the atmosphere light to achieve the efficacy of the desired color light, but can control the brightness of the illumination light as well. Moreover, quick assembly meets the needs of the user by a first coupling structure which can couple the first lamp shell to the second lamp shell. In addition, light-adjustment can be intuitively performed by the user. All the user has to do is select the desired light color, and then a wireless signal related to the desired color is generated and transmitted to the receiver. Later on, a control unit adjusts the atmosphere light and the illumination light according to the adjusting information received by the receiver, which can create a comfortable living atmosphere easily by adjusting these lights automatically.

The above embodiments and advantages of the present invention will become more readily apparent to those ordinarily skilled in the art after reviewing the following detailed descriptions and accompanying drawings.

### BRIEF DESCRIPTION OF THE DRAWINGS

FIG. 1 shows an illumination device according to the preferred embodiment of the present disclosure;

FIG. 2 shows a control unit according to the preferred embodiment of the present disclosure;

FIG. 3(a) shows a light-adjusting device according to the preferred embodiment of the present disclosure;

FIG. 3(b) shows a light-adjusting signal according to the preferred embodiment of the present disclosure;

FIG. 4 shows an illumination device according to the preferred embodiment of the present disclosure;

FIG. 5 shows a control unit according to the preferred embodiment of the present disclosure;

FIG. 6 shows a light adjustment by using a mobile device according to the preferred embodiment of the present disclosure; and

FIG. 7 shows an illumination device according to the preferred embodiment of the present disclosure.

### DETAILED DESCRIPTION OF THE PREFERRED EMBODIMENTS

Please refer to all Figs. of the present invention when reading the following detailed description, wherein all Figs. of the present invention demonstrate different embodiments of the present invention by showing examples, and help the skilled person in the art to understand how to implement the present invention. The present examples provide sufficient embodiments to demonstrate the spirit of the present invention, each embodiment does not conflict with the others, and new embodiments can be implemented through an arbitrary combination thereof, i.e., the present invention is not restricted to the embodiments disclosed in the present specification.

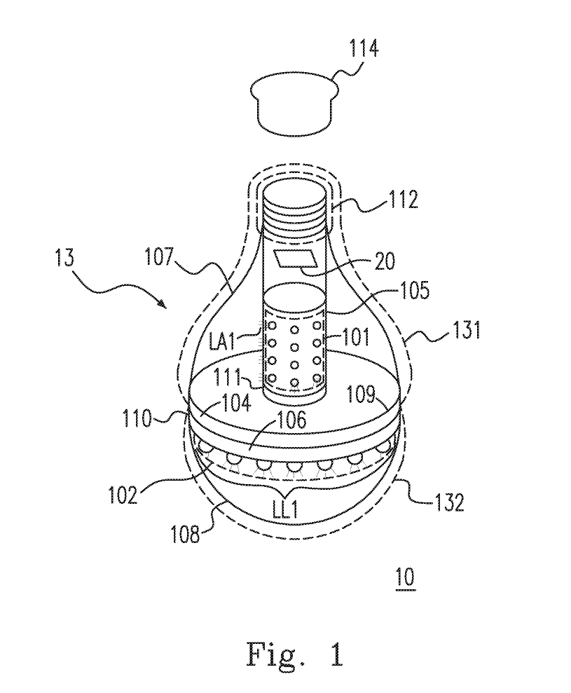

Please refer to FIG. 1, which shows an illumination device 10 according to the preferred embodiment of the present disclosure. The illumination device includes a first lamp 101, a second lamp 102 and a housing 103. The first lamp 101 is configured to provide a light source for the atmosphere of the living environment LA1. The second lamp 102 is configured to provide an illumination light source LL1. The housing 103 has a first portion 131 and a second portion 132 for accommodating the first and the second lamps 101 and 102 respectively. The first and the second portions 131 and 132 block the illumination light source LL1 and the light source for the atmosphere of the living environment LA1 respectively.

In FIG. 1, the first portion 131 includes a lamp carrier structure 105, a first lamp shell 107 and a first light-blocking unit 109. The lamp carrier structure 105 carries thereon the first lamp 101. The first lamp shell 107 is configured to enclose the lamp carrier structure 105. The first light-blocking unit 109 has a first coupling structure 111, and blocks the illumination light source LL1, wherein the lamp carrier 105 is coupled to the first light-blocking unit 109 by the first coupling structure 111. The second portion 132 includes a second light-blocking unit 110 and a second lamp shell 108. The second light-blocking unit 110 has a second coupling structure 106, is back-to-back coupled to the first light-blocking unit 109, carries the second lamp 102, and blocks the light source for the atmosphere of the living environment LA1. The second lamp shell 108 is configured to enclose the second light-blocking unit 110, wherein the first lamp 101 is separated from the second lamp 102 by the first light-blocking unit 109 and the second light-blocking unit 110, and the first lamp shell 107 and the second lamp shell 108 are coupled together by the second coupling structure 106.

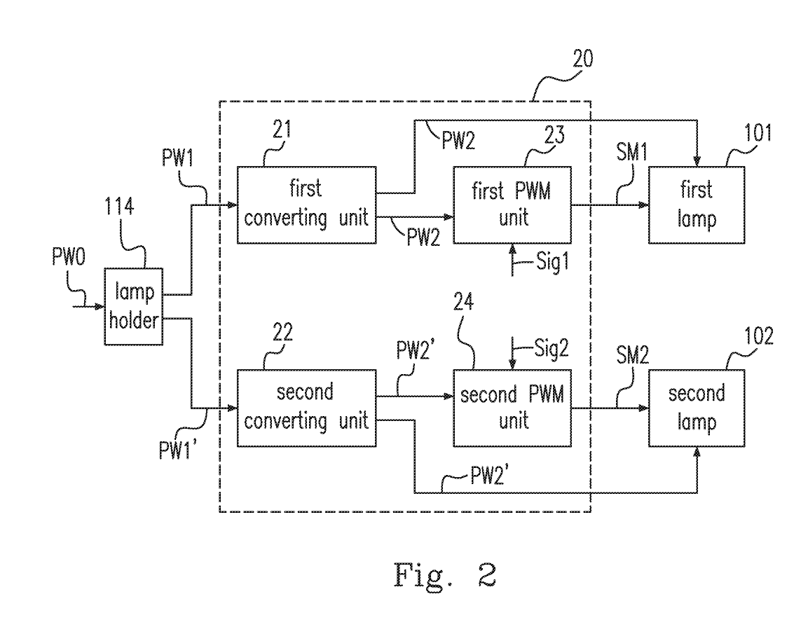

In FIG. 1, the first and the second light-blocking units 109 and 110 are partition boards isolating the first and the second portions 131 and 132 from each other. The second coupling structure 110 includes a second external screw thread engaging with the second lamp shell 108. The first coupling structure 109 includes one selected from the group consisting of an inner screw thread adapted to the lamp carrier unit structure 105, a joining glue, and a soldering tin for engaging with the first lamp shell 101. The first light-blocking unit 109 further includes a third coupling structure 104, which can be a first external screw thread and couples the first lamp shell 107 and the first light-blocking unit 109 together. Each of the first lamp 101 and the second lamp 102 is an LED lamp. The first portion 131 further includes a joint portion 112 configured to couple the illumination device 10 to a lamp holder 114 and the lamp carrier structure 105. The lamp holder 114 receives a power PW0 (shown in FIG. 2), which can be an alternating current (AC) power or a direct current (DC) power.

In FIG. 1, the first lamp 101 includes a red light LED (R-LED) unit, a green light LED (G-LED) unit and a blue light LED (B-LED) unit. The second lamp 102 includes a white light LED having a relatively high brightness. The first portion 131 further includes a control unit 20 configured to control an illuminating operation of at least one of the first lamp 101 and the second lamp 102.

Please refer to FIG. 2, which shows a control unit 20 according to the preferred embodiment of the present disclosure. The control unit 20 includes a first converting unit 21, a second converting unit 22, a first pulse width modulation (PWM) unit 23 and a second PWM unit 24. The first converting unit 21 is electrically connected to the lamp holder 114, and converts a first power PW1 to a second power PW2 provided to the first lamp 101. When the power PW0 is the AC power, the first converting unit 21 and the second converting unit 22 can be an AC to DC converter. The first PWM unit 23 receives the second power PW2, and in response to a first input signal Sig1, outputs a first light-adjusting signal SM1 adjusting at least one selected from the group consisting of the R-LED unit, the G-LED unit and the B-LED unit (not shown) to output the light source including a mixed light source for the atmosphere of the living environment LA1.

In FIG. 2, the second converting unit 22 is electrically connected to the lamp holder 114, and converts the first power PW1′ into a third power PW2′ provided to the second lamp 102. The second PWM unit 24 receives the third power PW2′, and in response to a second input signal Sig2, outputs a second light-adjusting signal SM2 adjusting the white-light LED to output the illumination light source LL1.

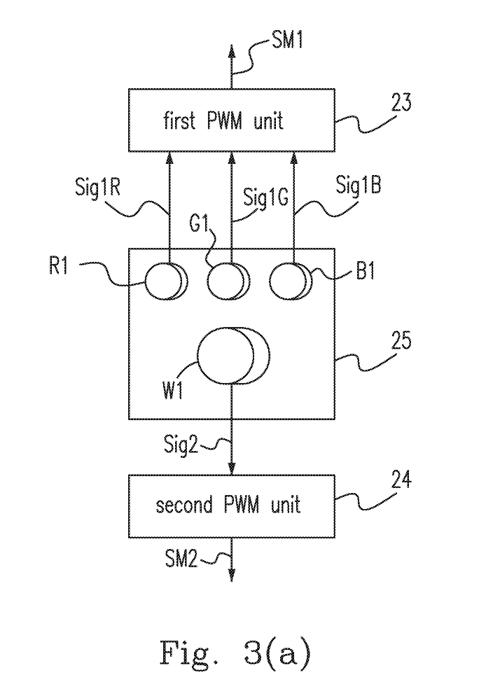

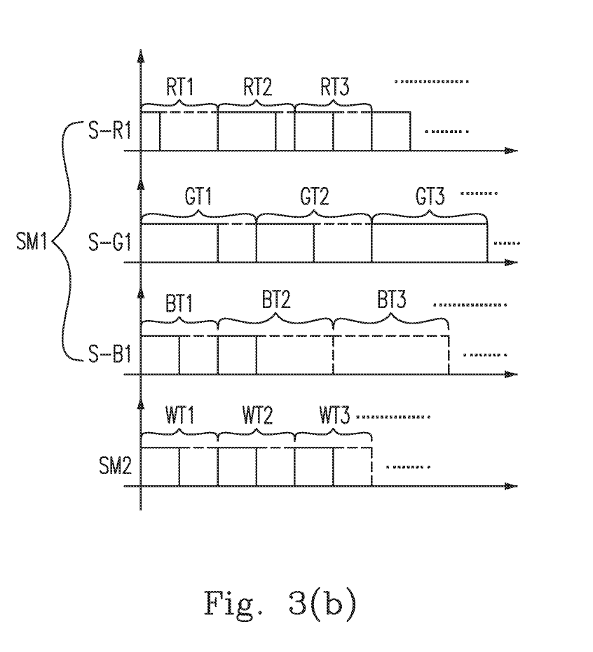

Please refer to FIG. 3(a), which shows a light-adjusting device 25 according to the preferred embodiment of the present disclosure. The light-adjusting device 25 can be arranged near the lamp holder 114 or the illumination device 10; and a quantized knob or a non-quantized knob can be used for adjusting the light. The light-adjusting device 25 includes knobs R1, G1, B1 and W1, which can respectively adjust the brightnesses of the R-LED unit, the G-LED unit, the B-LED unit respectively, and thus a desired mixed light source can be created. The knob W1 can adjust the brightness of the white LED for the purpose of the illumination. Preferably, the first input signal Sig1 is adjusted by a non-quantized knob (at least one of R1, G1 and B1), and the second input signal Sig2 is adjusted by a non-quantized knob W1.

Please refer to FIG. 3(b), which shows a light-adjusting signal according to the preferred embodiment of the present disclosure. FIG. 3(b) shows waveforms of a first PWM signal S-R1, a second PWM signal S-G1, a third PWM signal S-B1 and the second light-adjusting signal SM2 respectively. The vertical axis presents the amplitude of the corresponding signal, and the horizontal axis represents the time of the corresponding signal. The first light-adjusting signal SM1 includes a first PWM signal S-R1 having a first duty ratio, a second PWM signal S-G1 having a second duty ratio, and a third PWM signal S-B1 having a third duty ratio. The R-LED unit, the G-LED unit and the B-LED unit can emit three source lights having three brightnesses in response to the first PWM signal S-R1, the second PWM signal S-G1, and the third PWM signal S-B1 respectively. The three source lights form the light source for the atmosphere of the living environment LA1. The three brightnesses derived from the R-LED unit, the G-LED unit and the B-LED unit depend on the first, second and the third duty ratio respectively.

In one preferred embodiment, in FIG. 3(b), the knobs R1, G1 and B1 can be variable resistors, and the first input signal Sig1 includes signals Sig1R, Sig1G, Sig1B. When the corresponding knob is adjusted, the corresponding resistance is varied to adjust the first input signal Sig1 (Sig1R, Sig1G and Sig1B) which is input to the first PWM unit 23, and then the first PWM unit 23, in response to a change of the first input signal Sig1 (Sig1R, Sig1G, Sig1B) (which can be a change of voltage or current), adjusts the pulse width of the first PWM signal S-R1, the pulse width of the second PWM signal S-G1, and the pulse width of the third PWM signal S-B1. For example, the pulse width in a first cycle RT1 of the first PWM signal S-R1 is 25% pulse width, but the pulse width in a second cycle of the first PWM signal S-R1 is adjusted to 75% pulse width, which can make the light emitted from the R-LED unit brighter, and thus can mix with other light emitted from the G-LED unit and the B-LED unit to create a mixed light with different atmosphere, and which can create an atmosphere for a living environment. Similarly, the pulse width in the third cycle of the first PWM signal S-R1 may also be adjusted according to the requirement.

In FIG. 3(b), the cycles of the first PWM signal S-R1, the second PWM signal S-G1 and the third PWM signal S-B1 can be the same or different. For example, the cycle RT1 of the first PWM signal S-R1 is different from the cycle GT1 of the second PWM signal, which can satisfy the requirement of brightness with good flexibility. The cycle in each PWM signal can adaptively be adjusted. For example, the second cycle BT2 in the third PWM signal S-B1 can be adjusted based on the first cycle BT1, the second cycle BT2 is longer than the first cycle BT1, which can be achieved by adjusting another knob, i.e., the corresponding pulse width of the first PWM signal S-R1, the second PWM signal S-G1 and the third PWM signal S-B1 can be adjusted by one set of adjusting knobs, while another set of adjusting knobs can be used to adjust the corresponding cycle (or frequency) of the three PWM signals S-R1, S-G1, S-B1.

The method of adjusting the white light is similar to that of adjusting the R-LED unit, the G-LED unit and the B-LED unit. The user can adjusts the knob W1 which may be a variable resistor. When the knob W1 is adjusted, the resistance of the resistor varies and the second input signal Sig2 inputted to the second PWM unit 24 is adjusted accordingly. Then, the second PWM unit 24, in response to the second input signal Sig2, adjusts the pulse width of the second light-adjusting signal SM2. For example, each of the pulse widths of the first cycle WT1, the second cycle WT2 and the third cycle is adjusted to 50% of each cycle thereof.

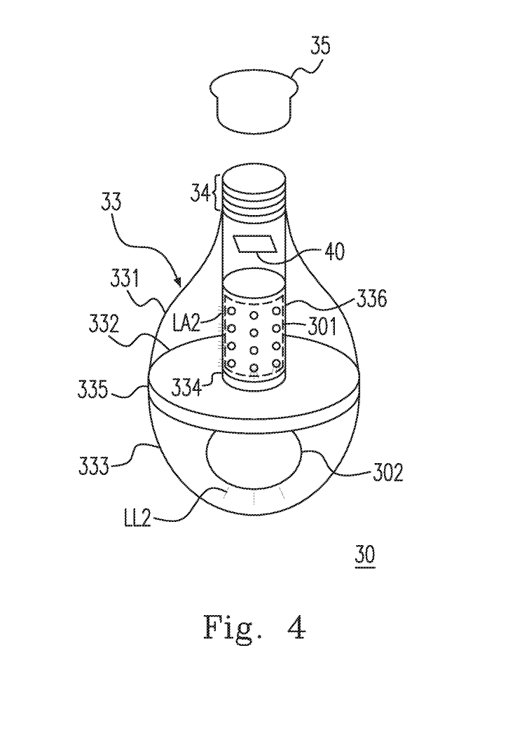

Please refer to FIG. 4, which shows an illumination device 30 according to the preferred embodiment of the present disclosure. The illumination device 30 can create an atmosphere of the living environment, and includes a first lamp 301, a second lamp 302 and a housing 33. The first lamp 301 is configured to provide a light source for the atmosphere of the living environment LA2. The second lamp 302 is configured to provide an illumination light source LL2. The housing 33 is configured to accommodate the first and the second lamps 301, 302. The illumination device 30 may have a plurality of lamps and a plurality of lamp shells. For example, the illumination device 30 in FIG. 4 includes a detachable lamp shell or all-in-one lamp shell, and the all-in-one lamp shell can be manufactured by 3D printing. Practically speaking, the housing 33 includes a first lamp shell 331, a light-blocking unit 332 and a second lamp shell 333. The first lamp shell 331 is configured to enclose the first lamp 301. The light-blocking unit 332 has a first coupling structure 334 and a second coupling structure 335, and carries the second lamp 302. The illumination device 30 is different from the illumination device 10, and has only one light-blocking unit 332. The second lamp shell 333 is configured to enclose the light-blocking unit 332, wherein the first lamp 301 is separated from the second lamp 302 by the light-blocking unit 332, the light-blocking unit 332 isolates the light source for the atmosphere of the living environment LA2 from interfering with the illumination light source LL2, and the first and the second lamp shells 331 and 333 are coupled together by the second coupling structure 335.

In FIG. 4, the illumination device 40 further includes a lamp-carrier structure 336 carrying thereon the first lamp 301. The lamp-carrier structure 336 and the light-blocking unit 335 are coupled by the first coupling structure 334. The first lamp shell 331 encloses the lamp carrier structure 336. The light-blocking unit 332 is a partition board separating the first lamp 301 from the second lamp 302, and the second coupling structure 335 includes an external screw thread engaging with the second lamp shell 333. The first coupling structure 334 includes one selected from the group consisting of an inner screw thread, a joining glue and a soldering tin engaging thereon the lamp carrier structure 336. In one preferred embodiment, the first lamp 301 and the second lamp 302 are all LED lamps. The illumination device 30 further includes a joint portion 34 configured to couple the illumination device 30 with a lamp holder 35 and the lamp carrier structure 336.

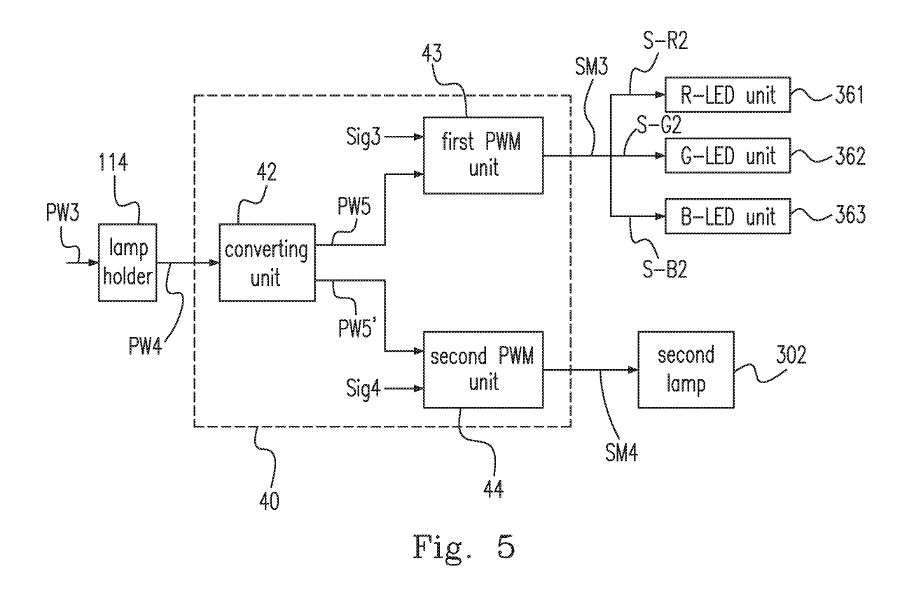

In FIG. 4, the control unit 40 can be arranged in the lamp-carrier structure 336 and may be arranged in the lamp holder 35. Similar to the illumination device 10, the control unit 40 includes a converting unit 42, a first PWM unit 43 and a second PWM unit 44 as shown in FIG. 5.

Please refer to FIG. 5, which shows a control unit 40 according to the preferred embodiment of the present disclosure. In FIG. 5, the lamp holder 5 receives a power PW3, which can be AC or DC power. The converting unit 42 is electrically connected to the lamp holder 35, and converts a first power PW4 from the lamp holder 35 to two second powers PW5 and PW5′ respectively provided to the first lamp 301 and the second lamp 302. The first PWM unit 43 receives the second power PW5, and outputs a first light-adjusting signal SM3 in response to a first input signal Sig3. The first light-adjusting signal SM3 adjusts the R-LED unit, the G-LED unit and the B-LED unit respectively to generate the light source for the atmosphere of the living environment LA2 including a mixed light source. The second PWM unit 44 receives the second power PW5′, and outputs a second light-adjusting signal SM4 in response to a second input signal Sig4, and the second light-adjusting signal SM4 adjusts the white LED to generate the illumination light source LL2.

In another preferred embodiment, the first lamp 301 includes a plurality of LED lamps, each included LED lamp includes the R-LED unit 361, the G-LED unit 362 and the B-LED unit 363, wherein the lights emitted from each included LED lamp can be mixed to form a different color light independently in response to the first light-adjusting signal SM3, including the white light. Similarly, the second lamp 302 can include the R-LED unit 361, the G-LED unit 362 and the B-LED unit 363, the lights of the primary colors emitted from the LED units 361, 362 and 363 can be mixed to form the white light, and therefore the LED units 361, 362 and 363 can form the white LED. The second lamp 302 may also include a plurality of white LEDs.

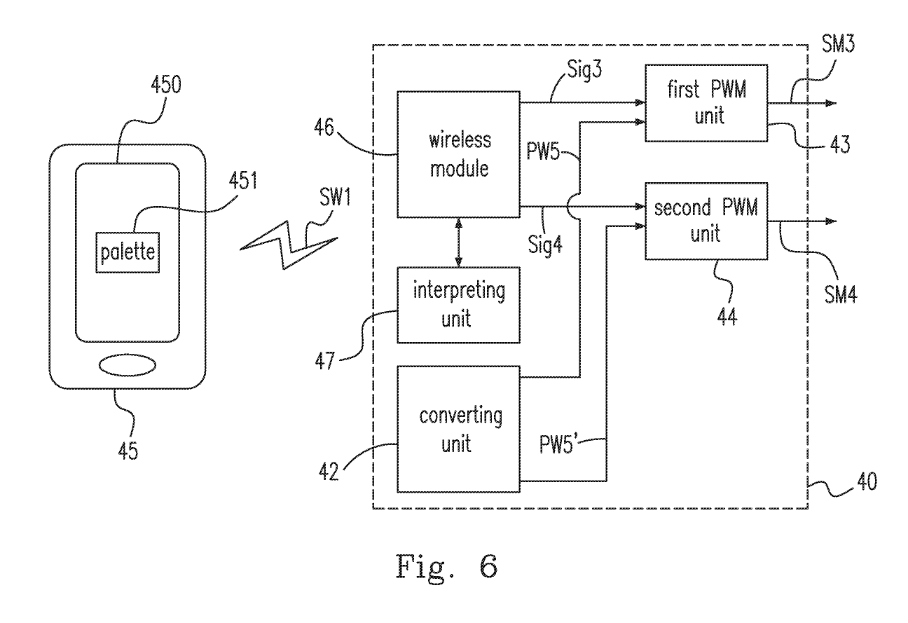

Please refer to FIG. 6, which shows a light adjustment by using a mobile device 45 according to the preferred embodiment of the present disclosure. The control unit 40 can further include a wireless module 46, which receives a wireless signal SW1 from the mobile device 45 to output the first signal Sig3 and the second signal Sig4, for adjusting the brightnesses of the R-LED unit 361, the G-LED unit 362, the B-LED unit 363 and the white LED. The display panel 450 of the mobile device 45 can display a palette 451, and there are many colors and grey scales shown thereon. For example, in the vertical direction of the palette 451, the palette 451 presents changes of the color scale including red, orange, yellow, green, blue, indigo and purple; while in the horizontal direction of the palette 451, the palette 451 presents changes of the grey scale. The user only touches the desired color of the light source for the atmosphere of the living environment LA2 by fingers, the wireless signal SW1 can be transmitted to the control unit 40 immediately, causing the first PWM unit 43 and the second PWM unit 44 to control the first light-adjusting signal SM3 and the second light-adjusting signal SM4 respectively, and thus the brightnesses of the R-LED unit 361, the G-LED unit 362, the B-LED unit 363 and the white LED can satisfy the requirement of user's expectation. More practically, for example, the following Table 1 can be established. When the user selects the desired color that he/she wants the illumination device 30 to emit, the application program of the mobile device 45 can directly determine a value representing the desired color according to the Table 1, and can directly send a corresponding wireless signal SW1 including the determined value to the control device 40.

TABLE 1

| | hue | | | |
|---|---|---|---|---|
| grey | Red hue | Green hue | Blue hue | |
| scale | 000~111 | 000~111 | 000~111 | mix |
| 000~111 | 111 + 111 | 111 + 111 | 000 + 000 | 111111111111000000 |
| 000~111 | 111 + 111 | 000 + 000 | 111 + 111 | 111111000000111111 |

In Table 1, each of the red hue, the green hue and the blue hue is represented by three binary bits; i.e., the red hue is represented by a value selected from eight different hue values (000-111), and each of the green hue and the blue hue is also represented by a value selected from eight different hue values (000-111). The grey scale represents brightness, and is also represented by three binary bits, and each color has a brightness selected from eight different brightnesses of grey scale. When the user selects the desired color of the palette 451, the application program of the mobile device 45 can generate a corresponding composite value including a corresponding RGB hue value and a corresponding grey scale value. For examples, in Table 1, the hue value of the red color is 111, the grey scale value of the red color is 111, and it means the red color is the most vivid red and the brightest red color. The hue value of the green color is 111, the grey scale value of the green color is 111, and it means the green color is the most vivid green and the brightest green color. The hue value of the blue color is 000, the grey scale value of the blue color is 000, and it means the blue color is the palest blue and the darkest blue color. All the above values can be concatenated together to get the mixed value of eighteen binary bits 111111111111000000. In this preferred embodiment, the red color and the green color can be mixed together to obtain a bright yellow color, but the hue value of blue color is low and the brightness of the blue color is darkest, and therefore the mixed color light of the red light and the green light will be a yellow color light after mixing the three primary color lights. When the user selects the bright yellow color by his/her intuition, the application program of the mobile device 45 can generate the corresponding composite value of the hue and the grey scale of the yellow color in real time, which is 111111111111000000.

Similarly, in Table 1, another preferred embodiment shows that the hue value of the red color is 111, the grey scale value of the red color is 111, and it means the red color is the most vivid red and the brightest red color. The hue value of the green color is 000, the grey scale value of the green color is 000, and it means the green color is the palest green and the darkest green color. The hue value of the blue color is 111, the grey scale value of the blue color is 111, and it means the blue color is the most vivid blue and the brightest blue color. All the above values can be concatenated together to get the mixed value of eighteen binary bits 111111000000111111. In this preferred embodiment, the red color and the blue color can be mixed together to obtain a bright purple color, but the hue value of green color is low and the brightness of the green color is darkest, and therefore the mixed color light of the red light and the blue light will be a purple color light after mixing the three primary color lights. When the user selects the bright purple color by his/her intuition, the application program of the mobile device 45 can generate the corresponding composite value of the hue and the grey scale of the purple color in real time, which is 111111000000111111.

In other preferred embodiment, the mobile device 45 can has a built-in color code table as shown in Table 2. When the user selects the desired color he/she wants the illumination device 30 to emit, the color code will be transmitted to the control unit 40 by the wireless signal SW1 in real time.

TABLE 2

hue

| grey | Color code | |
|---|---|---|
| scale | 0000~FFFF | mix |
| 00~FF | FF + 2E3A | FF2E3A |

Taking for an example, in Table 2, the hue is represented by the color code having four hexadecimal digits, and the grey scale is presented by two hexadecimal digits. In this preferred embodiment, the number of digits can be adjusted flexibly, depending on the requirement. When the user clicks to choose the hue and the brightness of the desired color in the palette 451, the corresponding color code 2E3A and the brightness value FF will be transmitted to the control unit 40 through the wireless signal SW1 including the corresponding color code 2E3A and the brightness value FF. The control unit 40 may further include an interpreting unit 47, which can convert the color code 2E3A to mixed proportion ratios of the red, the green and the blue colors. For examples, when the purple color having cooler blue component is chosen, the interpreter unit 47 converts the color code to mixed proportion ratios 30%, 10% and 60% of the RGB colors respectively. When the purple color having warmer red component is chosen, the interpreting unit 47 converts another color code to another mixed proportion ratios 60%, 10% and 30% of the RGB colors respectively. Meanwhile, the interpreting unit 47 transmits the grey scale value and the mixed proportion ratios of the RGB colors to the first PWM unit 43 and the second PWM unit 44, which can adjust the color of the mixed light emitting from the R-LED unit 361, the G-LED unit 362 and the B-LED unit 363, and the brightness of the second lamp 302 by using the method of adjusting pulse widths outputting from the first and the second PWM units 43 and 44.

Accordingly, please refer to Table 1 and FIG. 3(b). It is similar to the light-adjusting signals S-R1, S-G1, S-B1 and SM2 in FIG. 3(b), the grey scale of each color can be adjusted by adjusting the corresponding pulse width of the light-adjusting signal S-R2, S-G2, S-B2 or SM4 independently. On the other hand, the hue value of each color depends on the pulse width proportion ratios of the corresponding light-adjusting signals S-R2, S-G2 and S-B2 thereamong. For examples, the hue of the mixed color light includes 80% red hue, 20% green hue and 10% blue hue, which can be achieved by adjusting the pulse width proportion ratios of the corresponding light-adjusting signals S-R2, S-G2 and S-B2 thereamong. In order to demonstrate it simply and clearly, the starting point and the duration of the cycle of each light-adjusting signal is set to be the same. For example, the pulse width of the light-adjusting signal S-R2 is set to have 8 ins, the pulse width of the light-adjusting signal S-G2 is set to have 2 ins, and the pulse width of the light-adjusting signal S-B2 is set to have 1 ms. Later on, adjusting the corresponding pulse width of each light-adjusting signal respectively according to the grey scale of each primary color light, for examples, 50% grey scale of the red color, 40% grey scale of the green color, and 30% grey scale of the blue color. Accordingly, the pulse width of the light-adjusting signal S-R2 can be set to have 8×50%=4 ins, the pulse width of the light-adjusting signal S-G2 can be set to have 2×40%=0.8 ins, and the pulse width of the light-adjusting signal S-B2 can be set to have 1×30%=0.3 ins.

The information of hue and grey scale of each color in the aforementioned preferred embodiment can be interpreted to a single bit value or a plurality of bit values transmitted by the wireless signal SW1. For instance, the hue of each RGB color can be presented by 8 bits, and thus 24 bits presents a composite hue of RGB colors. The grey scale of the brightness of the mixed primary color light can be represented by using 8 bits, rather than by using 8 bits for each color light. Thus, it can reduce loading and data transmission for processing. On the contrary, when more bit numbers are used to represent the hue and grey scale, the more detailed or exact light is emitted from the illumination device 30.

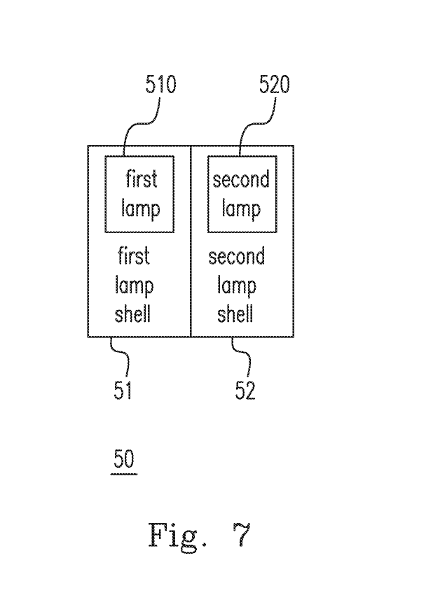

Please refer to FIG. 7, which shows an illumination device 50 according to the preferred embodiment of the present disclosure. The illumination device 50 includes a first lamp shell 51 and a second lamp shell 52. The first lamp shell 51 is configured to enclose at least a first lamp 510, and second lamp shell 52 is configured to enclose at least a second lamp 520, wherein the first and the second lamp shells 51, 52 are coupled back-to-back. This preferred embodiment can be combined with the aforementioned embodiments to create a new embodiment. For instance, the illumination device 50 further includes a lamp carrier structure 336 and a light-blocking unit 332; the lamp carrier structure 336 is configured to carry thereon at least the first lamp 310; and the light-blocking unit 332 has a first coupling structure 335 and a second coupling structure 334, and carries thereon at least the second lamp 302. Other similar components and structures are not described repeatedly.

In addition, among all of the aforementioned embodiments, one of the first lamp shell 51 and the second lamp shell 52 has a colored layer, and one of the first lamp shell 51 and the second lamp shell 52 is a semi-transparent lamp shell, and the other one is a full transparent lamp shell. Accordingly, the skilled person in the art can implement the present invention, which is rich in the industrial utilization.

### EMBODIMENTS

1. An illumination device for creating an atmosphere of a living environment includes a first lamp, a second lamp and a housing. The first lamp is configured to provide a light source for the atmosphere of the living environment; the second lamp is configured to provide an illumination light source; and the housing has a first portion and a second portion for accommodating the first and the second lamps respectively, wherein the first and the second portions block the illumination light source and the light source for the atmosphere of the living environment respectively.

2. The illumination device in Embodiment 1, wherein the light source for the atmosphere of the living environment provides a colored light, and the illumination light source provides a white light.

3. The illumination device of any one of Embodiments 1-2, wherein the first portion includes a lamp carrier structure, a first lamp shell and a first light-blocking unit. The lamp carrier structure carries thereon the first lamp; the first lamp shell is configured to enclose the lamp carrier structure; and the first light-blocking unit has a first coupling structure, and blocks the illumination light source.

4. The illumination device in one of Embodiments 1-3, wherein the second portion includes a second light-blocking unit and a second lamp shell. The second light-blocking unit has a second coupling structure coupling with the first light-blocking unit, carries thereon the second lamp, and blocks the light source for the atmosphere of the living environment; and the second lamp shell is configured to enclose the second light-blocking unit, wherein the first lamp and the second lamp are isolated by the first and the second light-blocking units, and the first and the second lamp shells are coupled by the second coupling structure.

5. The device of any one of Embodiments 1-4, wherein the first and the second light-blocking units are partition boards isolating the first and the second portions from each other; the second coupling structure includes an external screw thread engaging with the second lamp shell; and the first coupling structure includes one selected from the group consisting of an inner screw thread adapted to the lamp carrier structure, a joining glue and a soldering tin for engaging with the first lamp shell.

6. The device of any one of Embodiments 1-5, wherein the first lamp includes a red light LED (R-LED) unit, a green light LED (G-LED) unit and a blue light LED (B-LED) unit, and the second lamp includes a white light LED having a relatively high brightness.

7. The device of any one of Embodiments 1-6, wherein the first portion further includes a joint portion configured to couple the illumination device to a lamp holder and the lamp carrier structure.

8. The device of any one of Embodiments 1-7, wherein the first portion further includes a control unit configured to control an illuminating operation of at least one of the first lamp and the second lamp; and the control unit includes a first converting unit, a second converting unit, a first pulse width modulation (PWM) unit and a second PWM unit. The first converting unit is electrically connected to the lamp holder, and converts a first power to a second power supplying the first lamp; the second converting unit is electrically connected to the lamp holder, and converts the first power to a third power supplying the second lamp; the first PWM unit receives the second power, and in response to a first input signal, outputs a first light-adjusting signal adjusting at least one selected from the group consisting of the R-LED unit, the G-LED unit and the B-LED unit as the light source including a mixed light source for the atmosphere of the living environment; and the second PWM unit receives the third power, and in response to a second input signal, outputs a second light-adjusting signal adjusting the white-light LED as the illumination light source.

9. An illumination device for providing an atmosphere of a living environment includes a first lamp, a second lamp and a housing. The first lamp is configured to provide a light source for the atmosphere of the living environment; the second lamp is configured to provide an illumination light source; and the housing accommodates the first and the second lamps.

10. The illumination device in Embodiment 9, wherein the housing includes a first lamp shell, a light-blocking unit and a second lamp shell. The first lamp shell is configured to enclose the first lamp; the light-blocking unit has a first and a second coupling structures and carrying thereon the second lamp; and the second lamp shell is configured to enclose the light-blocking unit, wherein the first and the second lamps are separated by the light-blocking unit, the light-blocking unit isolates the light source for the atmosphere of the living environment from interfering with the illumination light source, and the first and the second lamp shells are coupled together by the second coupling structure.

11. The illumination device of any one of Embodiments 9-10, wherein the illumination device further includes a lamp-carrier structure carrying thereon the first lamp; the lamp-carrier structure and the light-blocking unit are coupled by the first coupling structure; the first lamp shell encloses the lamp carrier structure; the light-blocking unit is a partition board separating the first lamp from the second lamp; the second coupling structure includes an external screw thread engaging with the second lamp shell; and the first coupling structure includes one selected from the group consisting of an inner screw thread, a joining glue and a soldering tin engaging thereon the lamp carrier structure.

12. The illumination device of any one of Embodiments 9-11, wherein the illumination device further includes a joint portion configured to couple the illumination device with a lamp holder and the lamp carrier structure; the first lamp includes a red light LED (R-LED) unit, a green light LED (G-LED) unit and a blue light LED (B-LED) unit; and the second lamp includes a white light LED having a relatively high brightness.

13. The illumination device of any one of Embodiments 9-12, wherein the illumination device further includes a control unit configured to control an illuminating operation of at least one of the first lamp and the second lamp; and the control unit includes a converting unit, a first pulse width modulation (PWM) unit and a second PWM unit. The converting unit is electrically connected to the lamp holder and converts a first power to a second power supplying the first lamp and the second lamp. The first PWM unit receives the second power, and in response to a first input signal, outputs a first light-adjusting signal adjusting at least one selected from the group consisting of the R-LED unit, the G-LED unit and the B-LED unit of the first lamp to generate the atmosphere light source of the living environment including a mixed light source. The second PWM unit receives the second power, and in response to a second input signal, outputs a second light-adjusting signal adjusting the white-light LED as the illumination light source.

14. The illumination device of any one of Embodiments 9-13, wherein the first and the second input signals are adjusted by a mobile device; and the mobile device includes a display screen and has an application to display a palette on the display screen in order to provide a user to select a desired color, and transform the desired color to a color code.

15. The illumination device of any one of Embodiments 9-14, wherein the control unit further includes a wireless module and an interpreting unit. The wireless module receives the color code to output the first input signal and the second input signal; the first light-adjusting signal includes a first PWM signal having a first pulse width, a second PWM signal having a second pulse width and a third PWM signal having a third pulse width; the mixed light source has a hue depending on a proportion of the first, the second and the third pulse widths thereamong; the mixed light source has a gray scale depending on the first pulse width, the second pulse width and the third pulse width; and the interpreting unit converts the color code into the proportion of the first, the second and the third pulse widths.

16. An illumination device includes a first lamp shell and a second lamp shell. The first lamp shell is configured to enclose at least a first lamp; and the second lamp shell is configured to enclose at least a second lamp, wherein the first and the second lamp shells are coupled back-to-back.

17. The illumination device in Embodiment 16, wherein the illumination device further includes a lamp carrier structure and a light-blocking unit. The lamp carrier structure is configured to carry thereon at least the first lamp; and the light-blocking unit having a first coupling structure and a second coupling structure, and carrying thereon at least the second lamp. The lamp carrier structure is enclosed by the light-blocking unit and the first lamp shell; the first lamp and the second lamp are isolated from each other by the light-blocking unit coupling to the lamp carrier structure through the second coupling structure; the illumination device further includes at least an additional first lamp; the light-blocking unit is a partition board isolating at least one of the first lamps from the second lamp; the first coupling structure is an external screw thread engaging with the second lamp shell; and the second coupling structure is one selected from the group consisting of an inner screw thread, a joining glue and a soldering tin for engaging with the lamp carrier structure.

18. The illumination device of any one of Embodiments 16-17, wherein the illumination device further includes a joint portion configured to couple the illumination device to a lamp holder and the lamp carrier structure; and the first lamp includes a red light LED (R-LED) unit, a green light LED (G-LED) unit and a blue light LED (B-LED) unit, and the second lamp includes a white light LED having a relatively high brightness.

19. The illumination device of any one of Embodiments 16-18, wherein the illumination device further includes a control unit configured to control an illumination operation of at least one of the first lamp and the second lamp; and the control unit includes a converting unit, a first pulse width modulation (PWM) unit and a second PWM unit. The converting unit is electrically connected to a lamp holder, and converts a first power to a second power supplying the first lamp and the second lamp; the first PWM unit receives the second power, and in response to a first input signal, outputs a first light-adjusting signal adjusting at least one selected from the group consisting of the R-LED unit, the G-LED unit and the B-LED unit to generate a mixed light source; and the second PWM unit receives the second power, and in response to a second input signal, outputs a second light-adjusting signal to adjust the white light LED to generate an illumination light.

20. The illumination device of any one of Embodiments 16-19, wherein the first and the second input signals are adjusted by a non-quantized knob; the first light-adjusting signal includes a first pulse width modulation (PWM) signal having a first duty ratio, a second PWM signal having a second duty ratio and a third PWM signal having a third duty ratio, and the first, the second and the third duty ratios determine a brightness of light emitting from the R-LED unit, the G-LED unit and the B-LED unit; one of the first lamp shell and the second lamp shell has a colored layer; and one of the first lamp shell and the second lamp shell is a semi-transparent lamp shell, and the other one is a full transparent lamp shell.

While the invention has been described in terms of what is presently considered to be the most practical and preferred embodiments, it is to be understood that the invention need not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An illumination device for creating an atmosphere of a living environment, comprising:
a first lamp configured to provide a light source for the atmosphere of the living environment;
a second lamp configured to provide an illumination light source; and
a housing having a first portion and a second portion for accommodating the first and the second lamps respectively, wherein the first and the second portions block the illumination light source and the light source for the atmosphere of the living environment respectively.

2. The illumination device as in claim 1, wherein:
the light source for the atmosphere of the living environment provides a colored light; and
the illumination light source provides a white light.

3. The illumination device as in claim 1, wherein the first portion includes:
a lamp carrier structure carrying thereon the first lamp;
a first lamp shell configured to enclose the lamp carrier structure; and
a first light-blocking unit having a first coupling structure, and blocking the illumination light source.

4. The illumination device as in claim 3, wherein the second portion includes:
a second light-blocking unit having a second coupling structure coupling with the first light-blocking unit, carrying thereon the second lamp, and blocking the light source for the atmosphere of the living environment; and
a second lamp shell configured to enclose the second light-blocking unit, wherein the first lamp and the second lamp are isolated by the first and the second light-blocking units, and the first and the second lamp shells are coupled by the second coupling structure.

5. The illumination device as in claim 4, wherein
the first and the second light-blocking units are partition boards isolating the first and the second portions from each other;
the second coupling structure includes an external screw thread engaging with the second lamp shell; and
the first coupling structure includes one selected from the group consisting of an inner screw thread adapted to the lamp carrier structure, a joining glue and a soldering tin for engaging with the first lamp shell.

6. The illumination device as in claim 3, wherein:
the first lamp includes a red light LED (R-LED) unit, a green light LED (G-LED) unit and a blue light LED (B-LED) unit, and the second lamp includes a white light LED having a relatively high brightness.

7. The illumination device as in claim 6, wherein the first portion further includes a joint portion configured to couple the illumination device to a lamp holder and the lamp carrier structure.

8. The illumination device as in claim 7, wherein:
the first portion further includes a control unit configured to control an illuminating operation of at least one of the first lamp and the second lamp; and
the control unit includes:
a first converting unit electrically connected to the lamp holder, and converting a first power to a second power supplying the first lamp;
a second converting unit electrically connected to the lamp holder, and converting the first power to a third power supplying the second lamp;
a first pulse width modulation (PWM) unit receiving the second power, and in response to a first input signal, outputting a first light-adjusting signal adjusting at least one selected from the group consisting of the R-LED unit, the G-LED unit and the B-LED unit as the light source including a mixed light source for the atmosphere of the living environment; and
a second PWM unit receiving the third power, and in response to a second input signal, outputting a second light-adjusting signal adjusting the white-light LED as the illumination light source.

9. An illumination device for providing an atmosphere of a living environment, comprising:
a first lamp configured to provide a light source for the atmosphere of the living environment;
a second lamp configured to provide an illumination light source; and
a housing accommodating the first and the second lamps.

10. The illumination device as in claim 9, wherein:
the housing includes:
a first lamp shell configured to enclose the first lamp;
a light-blocking unit having a first and a second coupling structures and carrying thereon the second lamp; and
a second lamp shell configured to enclose the light-blocking unit, wherein the first and the second lamps are separated by the light-blocking unit, the light-blocking unit isolates the light source for the atmosphere of the living environment from interfering with the illumination light source, and the first and the second lamp shells are coupled together by the second coupling structure.

11. The illumination device as in claim 10, wherein:
the illumination device further comprises a lamp-carrier structure carrying thereon the first lamp;
the lamp-carrier structure and the light-blocking unit are coupled by the first coupling structure;
the first lamp shell encloses the lamp carrier structure;
the light-blocking unit is a partition board separating the first lamp from the second lamp;
the second coupling structure includes an external screw thread engaging with the second lamp shell; and
the first coupling structure includes one selected from the group consisting of an inner screw thread, a joining glue and a soldering tin engaging thereon the lamp carrier structure.

12. The illumination device as in claim 11, wherein:
the illumination device further includes a joint portion configured to couple the illumination device with a lamp holder and the lamp carrier structure;
the first lamp includes a red light LED (R-LED) unit, a green light LED (G-LED) unit and a blue light LED (B-LED) unit; and
the second lamp includes a white light LED having a relatively high brightness.

13. The illumination device as in claim 12, wherein:
the illumination device further comprises a control unit configured to control an illuminating operation of at least one of the first lamp and the second lamp; and
the control unit includes:
a converting unit electrically connected to the lamp holder and converting a first power to a second power supplying the first lamp and the second lamp;
a first pulse width modulation (PWM) unit receiving the second power, and in response to a first input signal, outputting a first light-adjusting signal adjusting at least one selected from the group consisting of the R-LED unit, the G-LED unit and the B-LED unit of the first lamp to generate the atmosphere light source of the living environment including a mixed light source; and
a second PWM unit receiving the second power and in response to a second input signal, outputting a second light-adjusting signal adjusting the white-light LED as the illumination light source.

14. The illumination device as in claim 13, wherein:
the first and the second input signals are adjusted by a mobile device; and
the mobile device includes a display screen and has an application to display a palette on the display screen in order to provide a user to select a desired color, and transform the desired color to a color code.

15. The illumination device as in claim 14, wherein:
the control unit further includes a wireless module and an interpreting unit, wherein the wireless module receives the color code to output the first input signal and the second input signal;
the first light-adjusting signal includes a first PWM signal having a first pulse width, a second PWM signal having a second pulse width and a third PWM signal having a third pulse width;
the mixed light source has a hue depending on a proportion of the first, the second and the third pulse widths thereamong;
the mixed light source has a gray scale depending on the first pulse width, the second pulse width and the third pulse width; and
the interpreting unit converts the color code into the proportion of the first, the second and the third pulse widths.

16. An illumination device, comprising:
a first lamp shell configured to enclose at least a first lamp; and
a second lamp shell configured to enclose at least a second lamp, wherein the first and the second lamp shells are coupled back-to-back.

17. The illumination device as in claim 16, wherein:
the illumination device further comprises:
a lamp carrier structure configured to carry thereon at least the first lamp; and
a light-blocking unit having a first coupling structure and a second coupling structure, and carrying thereon at least the second lamp,
the lamp carrier structure is enclosed by the light-blocking unit and the first lamp shell;
the first lamp and the second lamp are isolated from each other by the light-blocking unit coupling to the lamp carrier structure through the second coupling structure;
the illumination device further includes at least an additional first lamp;
the light-blocking unit is a partition board isolating at least one of the first lamps from the second lamp;
the first coupling structure is an external screw thread engaging with the second lamp shell; and
the second coupling structure is one selected from the group consisting of an inner screw thread, a joining glue and a soldering tin for engaging with the lamp carrier structure.

18. The illumination device as in claim 17, wherein:
the illumination device further comprises a joint portion configured to couple the illumination device to a lamp holder and the lamp carrier structure; and
the first lamp includes a red light LED (R-LED) unit, a green light LED (G-LED) unit and a blue light LED (B-LED) unit, and the second lamp includes a white light LED having a relatively high brightness.

19. The illumination device as in claim 18, wherein:
the illumination device further comprises a control unit configured to control an illumination operation of at least one of the first lamp and the second lamp; and
the control unit includes:
a converting unit electrically connected to a lamp holder and converting a first power to a second power supplying the first lamp and the second lamp;
a first pulse width modulation (PWM) unit receiving the second power and in response to a first input signal, outputting a first light-adjusting signal adjusting at least one selected from the group consisting of the R-LED unit, the G-LED unit and the B-LED unit to generate a mixed light source; and
a second PWM unit receiving the second power and in response to a second input signal, outputting a second light-adjusting signal to adjust the white light LED to generate an illumination light.

20. The illumination device as in claim 19, wherein:
the first and the second input signals are adjusted by a non-quantized knob;
the first light-adjusting signal includes a first pulse width modulation (PWM) signal having a first duty ratio, a second PWM signal having a second duty ratio and a third PWM signal having a third duty ratio, and the first, the second and the third duty ratios determine a brightness of light emitting from the R-LED unit, the G-LED unit and the B-LED unit;
one of the first lamp shell and the second lamp shell has a colored layer; and
one of the first lamp shell and the second lamp shell is a semi-transparent lamp shell, and the other one is a full transparent lamp shell.
